(19) United States
(12) Patent Application Publication
(10) Pub. No.: US 2024/0382789 A1
(43) Pub. Date: Nov. 21, 2024

(54) FLAME MITIGATION DEVICE FOR FUEL CONTAINER

(71) Applicant: SCEPTER U.S. HOLDING COMPANY, Akron, OH (US)

(72) Inventors: Krishnar KONESHON, Whitby (CA); Arash NIK-SERESHT, Aurora (CA)

(21) Appl. No.: 18/692,610

(22) PCT Filed: Sep. 16, 2022
(86) PCT No.: PCT/US2022/076601

§ 371 Date: Mar. 15, 2024

Related U.S. Application Data
(60) Provisional application No. 63/244,968, filed on Sep. 16, 2021.

(51) Int. Cl. A62C 3/06; A62C 4/00

(52) U.S. Cl. CPC A62C 3/065; A62C 4/00

(57) ABSTRACT

A flame mitigation device (FMD) for use within a portable fuel container. The FMD includes a rigid portion comprising a hollow body and a flange at least partially surrounding an opening in the hollow body. Additionally, the FMD includes a flexible portion composed of a sheet of permeable material extending from the hollow body. The sheet of permeable material defines an interior volume between a first end and a second end. Further, the first end has an opening in fluid communication with the hollow body. Additionally, the second end is sealed.

### CROSS-REFERENCE TO RELATED APPLICATION

This application claims priority benefit of U.S. Provisional Patent Application Ser. No. 63/244,968 filed Sep. 16, 2021, entitled “FLAME MITIGATION DEVICE FOR FUEL CONTAINER,” the complete disclosure of which is herein incorporated by reference in its entirety.

### TECHNICAL FIELD

The present disclosure relates to a flame mitigation device/flame arrestors for fuel container assemblies incorporating the same. The flame mitigation devices have application with portable fuel containers and will be described with particular reference thereto. However, it is to be appreciated that the present exemplary embodiments are also amenable to other like applications.

### BACKGROUND

Consumer and commercial portable fuel containers (CPFCs) are well known in the art. They are used to transport, store and dispense diesel fuel and gasoline. Consumers utilize the CPFCs in connection with a fuel tank typically associated with an internal combustion engine such as a lawnmower, chain saw, snowmobile, power generator or the like. As used herein, the term, portable fuel container refers to a container that can be transported by a user. Such portable fuel containers have traditionally been constructed of metal or synthetic resin.

A flame mitigation device (“FMD”) is a safety device intended to reduce the chance of some types of fires and explosions within portable fuel storage containers, among other things. In theory, an FMD functions by absorbing the heat from a flame front traveling at subsonic velocities, thus dropping the burning gas/air mixture below its auto-ignition temperature; consequently, the flame cannot survive. FMDs can also reduce the chances the flashback explosions which occur when vapor escaping the container contacts a flame or a spark. The vapor can ignite and “flash back” inside the container. The present disclosure provides certain improvements to current FMD designs.

### SUMMARY OF DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment, a flame mitigation device is provided. The flame mitigation device can comprise a rigid portion comprising a hollow body and a flange at least partially surrounding an opening in the hollow body. Additionally, the flame mitigation device can comprise a flexible portion composed of a sheet of permeable material extending from the hollow body. The sheet of permeable material can define an interior volume between a first end and a second end. The first end has an opening in fluid communication with the hollow body. Additionally, the second end is sealed.

According to another embodiment, a container assembly is provided. The container assembly comprises a fuel container that includes one or more walls that define a hollow tank body and a neck, where the neck defines an opening. The container assembly can also comprise a flame mitigation device, which can include a rigid portion and a flexible portion. The rigid portion can be positioned within the neck, where a flange of the rigid portion abuts an outer portion of the neck or an inner surface of the neck. The flexible portion can be composed of a sheet of permeable material extending from the rigid portion into an interior of the hollow tank body.

According to another embodiment, a method of manufacturing a container assembly is provided. The method can comprise providing a flame mitigation device comprising a flexible portion fixed to a rigid portion, wherein the flexible portion is composed of permeable material, and wherein the rigid portion comprises a hollow body. The method can further comprise inserting the flame mitigation device into an opening of a fuel container. Additionally, the method can comprise bonding the flame mitigation device to the fuel container.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is cross-sectional illustration of an exemplary fuel container with a flame mitigation device (“FMD”) in accordance with one or more embodiments described herein.

FIG. 2A is an illustration of an exemplary FMD in accordance with one or more embodiments described herein.

FIG. 2B is an illustration of an exemplary rigid portion of the assembled FMD of FIG. 2A.

FIG. 3 is a perspective view of another exemplary rigid portion of an FMD in accordance with one or more embodiments described herein.

FIG. 4 is a photograph of the sealed end of an exemplary flexible portion in accordance with one or more embodiments described herein.

FIG. 5 is a cross-sectional illustration of an exemplary FMD installed to a neck of a container in accordance with one or more embodiments described herein.

FIG. 6 is another cross-sectional illustration of an exemplary FMD installed to a neck of a container in accordance with one or more embodiments described herein.

FIG. 7 is a cross-sectional illustration of an exemplary FMD installed to a neck of a container in accordance with one or more embodiments described herein.

FIG. 8 is a close up cross-sectional illustration of an exemplary FMD installed to a neck of a container in accordance with the present disclosure.

FIG. 9 is a block diagram of an exemplary method for manufacturing and FMD and container assembly in accordance with one or more embodiments described herein.

FIG. 10 is an illustration of a flexible portion of an FMD attached to the interior surface of the rigid portion in accordance with one or more embodiments described herein.

FIG. 11A is an illustration of a flexible FMD attached to the interior surface of the neck of a container in accordance with one or more embodiments described herein.

FIG. 11B is a photograph of a flexible FMD attached to the interior surface of the neck of a container in accordance with one or more embodiments described herein.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The present disclosure relates, generally to flexible FMD's designed to quench or dissipate the heat of a flame. The FMD includes both a rigid top portion and a flexible portion extending therefrom that is configured to project into the container body. The flexible portion may flex to accommodate the insertion of a gas nozzle and the like.

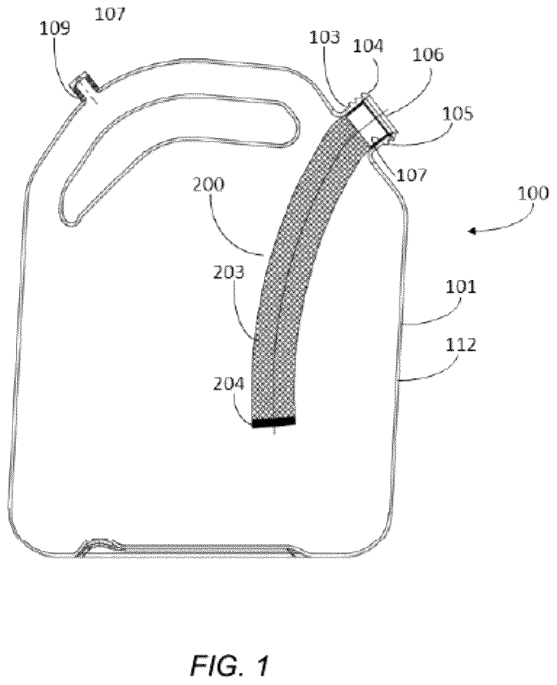

Referring now to FIG. 1, shown is an illustration of an exemplary fuel reservoir such as container 100, which may be referenced throughout this disclosure. The container 100 may be suited for use with a flame mitigation device (“FMD”) 200 according to an embodiment of the disclosure. With regard to FIG. 1, those skilled in the art will recognize that the portable fuel container 100 is shown as an example of the variety of different fuel containers with which the FMD 200 may be employed. For example, the FMD 200 is not limited in applicability and/or installation to the container 100 architecture (e.g., shape and/or dimensions) depicted in FIG. 1.

The fuel container 100 includes one or more walls 112 that forms a hollow tank body 101, and a neck 103 (e.g., a fill port for the container 100). The neck 103 may include a threaded outer surface 105 used to secure various attachments, such as a nozzle (not shown), thereto. The wall 112 can be any shape or dimension for receiving liquids (e.g., hydrocarbon-based fuels) within the hollow tank body 101. The one or more walls 112 can be made from a variety of polymers that can be shaped by, for example, injection molding and/or blow molding techniques. In one or more embodiments, the polymers of the one or more walls 112 do not degrade in the presence of volatile liquids (e.g., hydrocarbon-based fuels). For example and without limitation, nylon and polyethylene are suitable polymers for the construction of the fuel container 100 (e.g., of the wall 112). In various embodiments, the hollow tank body 101 can be molded of synthetic a resin, such as polyethylene. Additionally, the finish of the synthetic resin surface can be also specifically selected for minimizing the permeation of fuel through the one or more walls 112 and/or hollow tank body 101.

The one or more walls 112 can also defines the neck 103 that provides fluid communication between the hollow tank body 101 and an environment outside the container 100 (e.g., provides fluid communication with an environment surrounding the hollow tank body 101). The neck 103 can include one or more sidewalls that are formed by extensions of the external surface of the one or more walls 112. Alternatively, the neck 103 can comprise a hole in the one or more walls 112 and/or an annular flange that is secured about the hole. The annular flange can extend away from the external surface of the one or more walls 112 to provide sidewalls of the neck 103. Further, the sidewalls of the neck 103 can provide a surface for removably connecting an accessory such as a fill port cap and/or spout. For example, such an accessory can sealably connect by friction fit, snap fit, and/or a threaded connection (via threads 105) with an internal or external surface of the neck 103 sidewalls.

As illustrated in the exemplary embodiment of FIG. 1, the neck 103 can be spaced forwardly of a handle 107 that facilitates transport of the container 100. The neck 103 presents a substantially round opening 106 allowing fluid to ingress and egress from the hollow tank body 101. The neck 103 is preferably cylindrical and presents a threaded outer surface 105 and an inner surface. In use, a dispensing spout may cover the neck 103. The neck 103 is used for both filling and dispensing the fuel into and out of the fluid container 100. Those skilled in the art will recognize that the filling and dispensing locations on the container 100 may differ, such as being at separate locations on the container 100. A dispensing spout is generally threadably attached to the neck 103. Once attached, the spout is in fluid communication with the hollow tank body 101.

When the dispensing spout is removed, as shown in FIG. 1, a hole or opening 106 is exposed. The opening 106 permits filling the hollow tank body 101 with fuel (or other fluids). When the spout is removed, fuel may also be poured from the hollow tank body 101. The size of the opening 106 can be at least at least 2 square inches (50.3 mm²) but is typically not more than 10 square inches (254 mm²). The container 100 may also include a vent 109 for periodically venting the container 100 to atmosphere.

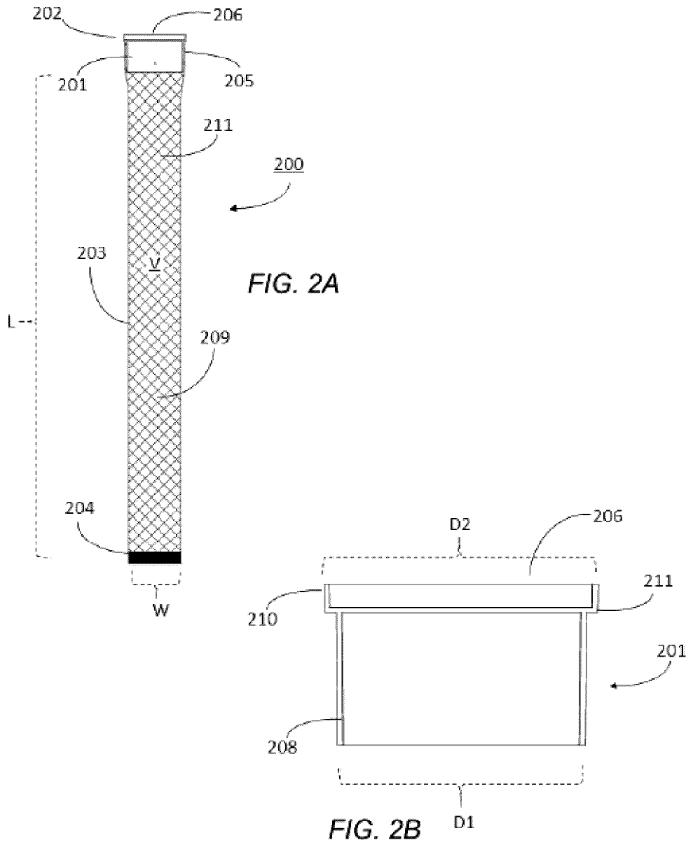

As exemplified in FIGS. 1 and 2A-B, the container 100 also includes a flame mitigation device (FMD) 200. The FMD 200 is used to mitigate spark and/or flame entering the interior of the hollow tank body 101. The FMD 200 is generally sized and shaped (i.e., configured) so to be capable of being inserted into the neck 103 of a portable fuel container 100. In the exemplary embodiments herein, the FMD 200 includes a first rigid portion 201 defining a top opening 206 within the FMD 200 about a first end 202. In some embodiments, the first rigid portion 201 is composed of a substantially rigid polymer material that does not degrade in the presence of volatile liquids, such as hydrocarbon-based fuels. Materials for the rigid portion include, but are not limited to: nylon, polyester, polyethylene, polypropylene, a combination thereof, and/or other synthetic resins compatible with the material the hollow tank body 101. In one or more embodiments, the rigid portion 201 is composed of high density polyethylene (“HDPE”) or a like material to the container 100. In various embodiments, the rigid portion 201 and the hollow tank body 101 can each be made of a polyethylene blend, each having different percentages of constituents.

The FMD 200 can also include a second flexible portion 203 composed of flexible polymer material and may have a substantially tubular shape. The flexible portion 203 extends from the first rigid portion 201 (e.g., within the container body 101) and terminates at a second end 204, opposite of the first end 202. The material of the flexible portion 203 may be made of any suitable material that does not degrade in the presence of volatile liquids (e.g., hydrocarbon-based fuels), including, but not limited to: Nylon, polyester, polyethylene, polypropylene, a combination thereof, and/or other synthetic resins compatible with the material the container body and resistant to chemical.

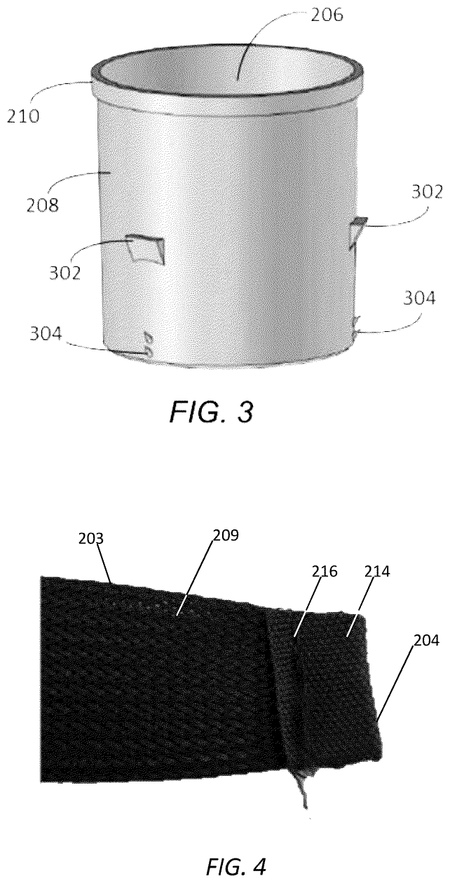

In some embodiments, the first rigid portion 201 includes an exterior sidewall that defines a hollow body 208 configured for insertion into the neck 103 of a container 100. The hollow body 208 has a first outer periphery (e.g., outer diameter D1) that can be smaller than the inner diameter of the neck 103. In some embodiments, and as illustrated in FIGS. 2A-3, the first rigid portion 201 can include a top flange 210 located about the first end 202 of the FMD 200. Further, the top flange 210 can have an outer periphery (e.g., a second outer diameter D2) that can be greater than the first outer periphery (e.g., first outer diameter D1) of the substantially hollow body 208. In the illustrated embodiments, the hollow body 208 of the first rigid portion 201 can be substantially cylindrical in shape; however, it is to be appreciated that other shapes substantially complementary in shape to the neck 103 are also envisaged without departing from the scope of this disclosure. In general, the top flange 210 has an edge perimeter 211 that extends from, and is positioned over, the hollow body 208 and is configured to engage the neck 103 as described in greater detail below.

The top flange 210 can defined a ledge that is configured to engage the neck 103 of a container 100 such that the FMD 200 is prevented from falling into the interior of the hollow tank body 101. In some embodiments, as exemplified in FIGS. 1-2B, the top flange 210 can be configured to abut the outer edge 104 of the neck 103 about the opening 106. This abutment allows the hollow body 208 of the first rigid portion 201 to insert (along with the connected flexible portion 203) into the opening 106 of the neck 103 and prevent the FMD 200 from advancing through the neck 103 (e.g., from falling into the container 100). In other embodiments, the top flange 210 can be configured to engage an inner surface 107 of the neck 103 and prevent the FMD 200 from falling into the container 100. In some embodiments, the inner surface 107 of the neck 103 has a decreasing inner dimension (e.g., an increasing internal diameter), from the outer edge 104 toward the container body 101. In these embodiments, the flange 210 abuts the inner surface 107 at a point where the inner diameter of neck 103 matches the outer diameter D2 of the top flange 210. In yet still other embodiments, the top flange 210 can be configured to engage an interior surface feature of the neck 103. For example, the interior surface 107 of the neck 103 can include a ledge (discussed in greater detail below) configured to abut the top flange 210 of the rigid first portion 201 of the FMD 200. For example, an inner surface of the neck 103 can include a ledge that projects into the opening

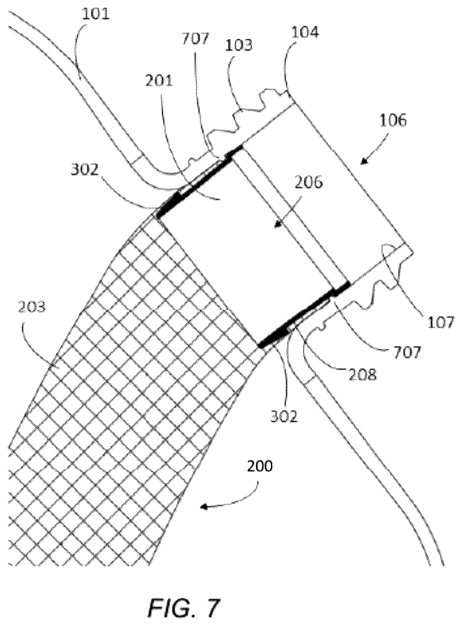

In some embodiments, and with reference to FIG. 3 the rigid portion 201 includes one or more cantilevered retention members 302. More specifically, the rigid portion 201 can have an exterior sidewall, defining the hollow body 208, that uses one or more cantilevered retention members 302 configured to prevent removal of the rigid portion 201 from within the portable fuel container 100. In some embodiments, the cantilevered retention members 302 are separated at 120-degree intervals on the exterior side wall of the hollow body 208 and about the perimeter of the FMD 200. Each retention member 302 can include a cantilever or sloped surface extending from the exterior side wall of the hollow body 208 (e.g., cantilevered or sloped away from the exterior side wall, as exemplified in FIG. 7). However, it is to be appreciated that any spaced apart relation of retention members 302 can be employed without departing from the scope of this disclosure. As shown in FIG. 3, the one or more retention members 302 can be spaced away from the top flange 210 along the sidewall. For example, the one or more retention members 302 can be positioned about 1 inch below the flange 210. In use, the one or more retention members 302 can each frictionally engage within the container 100, below the neck 103, and are used as a safety feature for preventing accidental removal of the FMD 200 from the interior of the fuel container 100.

As briefly mentioned above, the flexible portion 203 is connected to and extends from the sidewall of the hollow body 208 of the rigid portion 201. The flexible portion 203 is a generally a tubular, permeable, hollow structure terminating in a sealed or fused end 204. The flexible portion 208 is composed of a permeable flexible material including a plurality of openings 209 (holes). That is, the flexible portion 203 is a permeable material that can be flexible, deformable, bendable and/or expandable and embodied as a fibrous textile, mesh, combination thereof, and/or the like. The openings 209 can be sized to prevent the passage of a flame while allowing for a fluid to flow through the FMD 200. The fluid may flow through the FMD 200 by, for example, about 9 gallons per minute or greater. In various embodiments, the fluid flow through the FMD 200 can meet or exceed the specifications of ASTM F3326. When the FMD 200 is attached to a container 100 (as in FIG. 1) all fluid ingress or egress to or from the container 100 and passing through the opening 106 must also pass through the permeable medium (openings 209), thus providing a continuous barrier between an ambient exterior and the interior volume defined by the hollow tank body 101. The plurality of openings 209 in flexible portion 203 provide a mesh or porous surface for permitting the passage of fluids through the neck 103 to fill or employ the container 100 while providing an ignition-arresting structure to prevent flame flash-back.

In some embodiments, the flexible portion 203 is composed of a plurality of flame resistance polymer strands in a braided construction that allows fluid to flow in-between the openings 209 (holes) between strands 211. For example, the individual strands 211 (filaments) can have an overlapping braided construction that allows the flexible portion 203 to flex and elastically expand in response to external forces (e.g., bending, compression, flexing) while allowing fluid flow between the open spaces (openings 209) between strands 211. In some embodiments, the flexible portion is combined of an expandable braided material that can expand up to 150% of its original size. In other embodiments, the flexible portion 203 is composed of a sheet of permeable material that is wrapped about itself and/or sealed/fused to create a tubular shape.

In some embodiments, the openings 209 are substantially circular in shape. In other embodiments, the openings 209 are substantially rhombic. However, it is to be appreciated that openings 209 are not limited to any specific shape or size. Rather each opening 209 has an open area sufficient to quench a flame yet allow for the flow of fluid therethrough. In some embodiments, each opening 209 can have an open area of about 0.25 mm² to about 2 mm², including about 1.0 mm².

The flexible portion 203 has an open end 205 configured to engage the hollow body 208 of the rigid portion 201, where the open end 205 is opposite the sealed/fused end 204. In other words, the substantially tubular shape of the flexible portion 203 has a terminal end (sealed end 204) that is closed and does not allow for the passage of fluid. The flexible portion 203 therefore defines an interior volume V. The closed/seal end 204 is configured to withstand at least about 20 pounds of force. One end of the length of tube/sleeve flexible portion 203 can be sealed such that the flexible portion has an open end 205 and a sealed end 204 opposite the open end 205. The sealed end 204 may be heat sealed, sonically welded, adhesively sealed, and or mechanically bound (e.g., by stitching).

In one or more embodiments, as exemplified in FIGS. 1 and 4, the sealed end 204 includes an additional piece of material 214 to seal and/or reinforce the sealed end 204. In some embodiments, the material 214 is a fabric material that is folded over the terminal end 204 and sandwiches the flexible portion 203 on both sides. In some embodiments, the fabric material 214 may be stitched to the flexible portion 203 along a line parallel to the sealed end 204 and at a distance therefrom. In some embodiments, the stitching 216 is less than about 1.0 inch from the sealed end 204. In this way, the stitching 216 prevents expansion and flexing of the end 204. If an object (e.g., a nozzle from a fuel dispenser) is inserted to the FMD 200, the stitching 216 prevents additional travel of the nozzle along the flexible portion 203 and prevents damage to the sealed end 204. For ends 204 that are heat-sealed or welded, the stitching 216 prevents inadvertent cracking or separating of the sealed end 204. In other words, the sealed end 204 may be created by the additional fabric 214 stitched to the flexible material and/or the sealed end may be reinforced by stitching 216 spaced apart from the bonded end. The additional fabric 214 may be composed of a flame resistance material. In some embodiments, the additional fabric 214 may permeable and allow for the passage of fluids therethrough. In some embodiments, the additional fabric 214 has the same or similar properties as the material of the flexible portion 203.

In some embodiments, the sealed end 204 is sealed by welding/heat and stitching 216 is applied to the flexible portion 203 at a distance from the sealed end 204 without the placement of additional material 214. The stitching 216 may reinforce the sealed end 204 and prevent inadvertent expansion, bending, flexing, that could damage the sealed end.

In some embodiments and with continued reference to FIGS. 2A and 4, the flexible portion 203 includes a taper from the opening 206 to the sealed end 204. In some embodiments, the taper is along the width W, substantially parallel to the sealed end 204. That is, the flexible portion 203 has at least a portion of its length L where the width decreases towards the seal end 204. In some embodiments, the taper begins somewhere near the halfway point of its length. In some embodiments, the taper is present on last ¼ portion of the length L toward the sealed end 204. In some further embodiments, the taper is present on less than the last ¼ portion of the length L toward the sealed end 204.

The open end 205 of the flexible portion 203 is attached to exterior sidewall of the hollow body 208 of the rigid portion 202 and extends therefrom. That is, the hollow body 208 of the rigid portion is inserted into the open end 205 of the flexible portion 203 and the two portions are attached together. This attachment creates an “elongated pocket,” wherein the opening 206 of the rigid portion 201 is in communication with the interior volume V of the flexible portion 203. The attachment between the rigid portion 201 and flexible portion 203 is made such that there are no gaps or areas where fluid may ingress/egress between the rigid portion 201 and flexible portion 203. That is, when the FMD is attached to a container 100 all fluid entering the FMD 200 through the opening 206 of the rigid portion 201 must pass through the openings 209 in the flexible portion 203 and vice versa. With the flexible portion 203 attached to the exterior diameter of the rigid portion 201 objects inserted into the opening 206, e.g., the nozzle of a fuel dispenser, do not contact the interface between the flexible portion 203 and rigid portion 201.

In some embodiments, the flexible portion 203 is sealed to the sidewall of the hollow body 208 by a sealing adhesive. In other embodiments, the flexible portion 203 is sealed to the sidewall of the hollow body 208 with heat, e.g., heat sealing/locally melting. In other embodiments, the flexible portion 203 is sealed to the sidewall of the hollow body 208 by sonic welding. In other embodiments, attachment of the flexible portion 203 and rigid portion 201 include a combination of the above. In yet other embodiments, the flexible portion 203 is sealed to the sidewall of the hollow body 208 by spin welding. In yet other embodiments, the flexible portion 203 is sealed to the sidewall of the hollow body 208 by heat staking. Generally, it is desired that the attachment withstand at least about 15 pounds of force.

In some embodiments and with reference to FIG. 3, the rigid portion 201 includes a plurality of barbs 304 extending outward from the sidewall of the hollow body 208. With the flexible portion 203 in wrapping over and in sliding engagement with the hollow body 208, the barbs 304 engage openings 209 in the flexible portion 203 and hold the flexible portion 203 in a relative position with respect to the rigid portion 201. While the barbs 304 are illustrated as being positioned below the retaining members 302, it is to be appreciated that the barbs 304 may be posited anywhere on the hollow body 208 where the flexible portion 203 may overlap the hollow body 208. In some embodiments, the material of the barbs 304 is used to seal the rigid portion 201 to the flexible portion 203 by heat sealing and or welding.

The FMD 200 is inserted into the neck of the container 100, such that the FMD 200, and the flexible portion 203 thereof, is suspended in the interior volume of the hollow tank body 101 providing a flame mitigation property to the total container assembly 100. In certain embodiments, it may be desirable for the FMD 200 be permanently attached (i.e., non-removable) to the container 100 by, for example, bonding or welding the rigid portion 201 to the neck 103. The attachment of the FMD 200 to the neck 103 of the container is a sealed connection, meaning that all fluid exchange between the interior and exterior of the container takes place through the top opening 206 of the FMD 200 (and the permeable flexible portion 203).

In some embodiments, the FMD 200 is assembled and sealed to the inside surface 107 of the neck 103 of the container 100 by way of a frictional fit. Here, the interior surface of the neck 103 may have a decreasing inner dimension (e.g. diameter) towards the hollow tank body 101. In these embodiments, the top flange 210 abuts the inner surface 107 at a point which the inner diameter of neck 103 matches the outer diameter D2 of the flange 210. The top flange 210 and/or portions of the hollow body 208 are bonded to the interior surface 107 of the neck 103. Bonding may include but is not limited to welding, melting, heat staking, adhesively sealing.

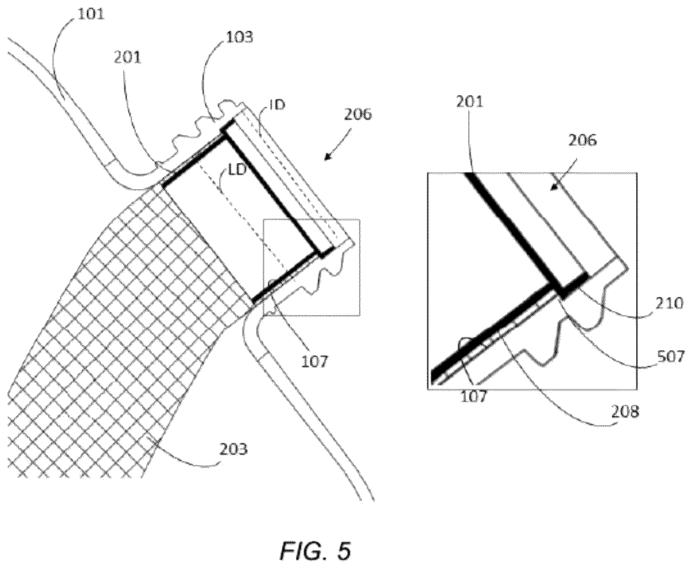

In other embodiments and with reference to FIG. 5, the flange 210 is configured to engage an interior surface feature of the neck 103. For example, the interior surface 107 of the neck 103 may include an annular ledge 507 having a diameter LD less that the initial diameter ID of the opening 106, and less than the outer diameter D2 of the hollow body 208. In this way, the flange 210 is prevented from falling into the hollow tank body 101 by abutment of the ledge 507 on the inner surface 107 of the neck 103. The flange 210 and/or portions of the hollow body 208 may be bonded to the interior surface 107 of the neck 103 and ledge 507. Bonding may include but is not limited to welding, melting, heat staking, adhesively sealing.

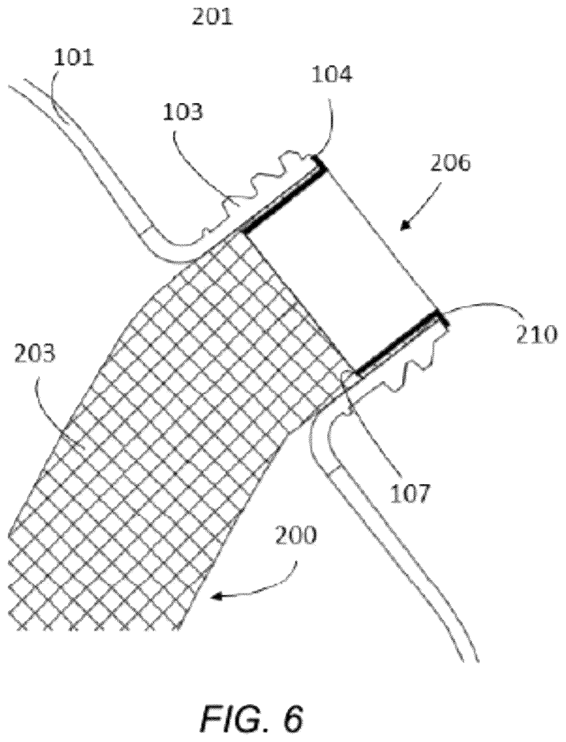

In some embodiments, as exemplified in FIG. 6, the top flange 210 is configured to abut and seal against the outer edge 104 of the neck 103. This abutment allows the hollow body 208 of the first rigid portion 201 to insert (along with the connected flexible portion 203) into the opening of the neck 103 and prevent the FMD 200 from advancing through the neck 103, i.e., falling into the container 100. The flange 210 may be bonded to outer edge 104. Bonding may include but is not limited to welding, melting, heat staking, adhesively sealing.

In some embodiments, as exemplified in FIG. 7, the FMD 200 is mechanically secured to the neck 103. Mechanical attachment may include, but is not limited to, use of fasteners, snap fit, press fit, and/or friction fit of the rigid portion 201 to some portion of the neck 103. In the exemplary embodiment of FIG. 7, the FMD 200 is mechanically secured to the neck 103 by way of retention members 302 as described in with respect to FIG. 3 and best understood with reference thereto. In use, the retention members 302 frictionally engage within the interior of the hollow tank body 101, below the neck 103, and are used as a safety feature for preventing accidental removal of the FMD 200 from the interior of the container 100. In some embodiments, the one or more retention members 302 engage below the container's 100 outer edge, where the sizing can be complementary such that the retention members 302 are sufficiently resilient and preferably able to deflect upon engagement. In some embodiments, the interior surface 107 also includes an interior surface feature 707, similar in some aspects to ledge 507 discussed in relation to FIG. 5. That is, the interior surface 107 of the neck 103 may include an annular interior surface feature 707 configured to prevent the top flange 210 (and therefore the FMD 200) from falling into the hollow tank body 101. In some embodiments, the interior surface feature 707 provides a sealing engagement with the top flange 210, such that fluid exchange between the interior volume of the hollow tank body 101 and exterior environment, only occurs through the opening 206 of the rigid portion 201 (and through the permeable flexible portion 203). In some further embodiments, the flange 210 and portions of the hollow body 208 of the rigid portion 201 may be bonded to the interior surface 107 of the neck. Bonding may include but is not limited to welding, melting, heat staking, adhesively sealing.

In some embodiments and with reference to FIG. 8, a top portion 803 of the flexible portion 203 is sandwiched between the exterior of the hollow body 208 of the rigid portion 201 and interior surface 107 of the neck 103. In some further embodiments, the top portion 803 is bonded to both the interior surface 107 and hollow body 208 to create a sealed attachment to the neck 103. Bonding may include but is not limited to welding, melting, heat staking, adhesively sealing. In this way, the bonded interface between the rigid portion 201 and flexible portion 203 are encased between rigid surfaces and protected from contact with objects inserted into the neck opening 106 and FMD opening 206.

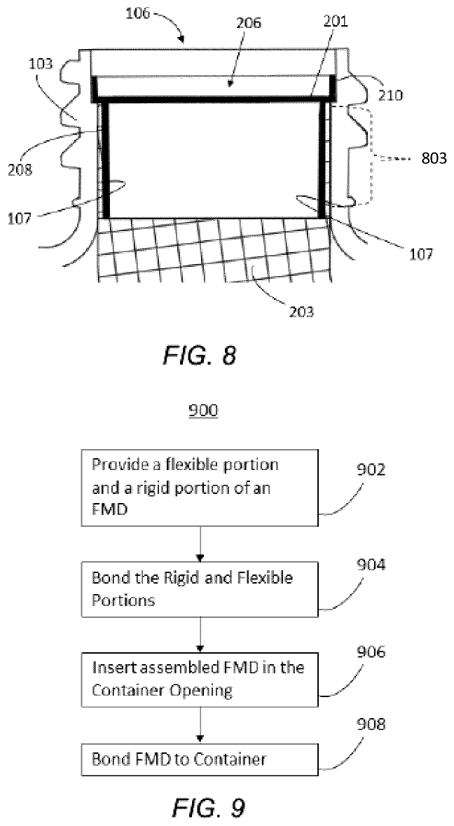

In accordance with another aspect of the present disclosure, methods for manufacturing an FMD equipped container are provided. FIG. 9 illustrates a block diagram of an exemplary method 900 for manufacturing an FMD 200 and container 100 assembly. At block 902, the method 900 includes providing a rigid portion 201 and flexible portion 203 of an FMD 200. The rigid portion 201 and flexible portion 203 are similar in many respects to the exemplary rigid portions 201 and flexible portions 203 described above and best understood in relation thereto. The providing at block 902 can include the steps of molding a rigid portion 201 to a shape having a hollow body 208 and a top flange 210. The providing at block 902 can also include cutting a length of flexible portion material to a desired length and sealing the end 204 as described above with respect to FIGS. 2 and 4 and understood with relation thereto. The seal of the sealed end is created with withstand a minimum of 15 pounds of force.

At block 904, the rigid portion 201 and flexible portion 203 is bonded together. That is, a top portion 803 of the tubular flexible portion 203 is wrapped over the exterior wall of the substantially hollow body 208 of the rigid portion 201 and the two are bonded together. Bonding can include, but is not limited to: welding, melting, heat staking, adhesively sealing, a combination thereof, and/or the like. In some embodiments, barb features 304 on the hollow body 208 can facilitate the bonding of the rigid portion 201 to the flexible portion 203. The bonding may withstand a minimum of 15 pounds of force without dislodging.

At block 906, the assembled FMD 200 is inserted into the opening 106 of the neck 103 of a container 100. In some embodiments, the FMD 200 can be seated within the neck 103. For example, the FMD 200 can be positioned such that the top flange 210 abuts the edge 104 of the neck 103 preventing further travel of the FMD 200 towards the container 100. In other embodiments, the top flange 210 abuts and/or engages a surface feature of the interior surface 107 of the neck 103. In yet still other embodiments, the FMD 200 includes one or more cantilevered retention members 302 as described above with respect to FIGS. 3 and 7 and understood in relation thereto. During insertion, the one or more retention members 302 can below the container outer edge wherein the sizing being complementary such that the retention members 302 are sufficiently resilient and preferably able to deflect upon engagement and secure the FMD 200 to the container 100.

At block 908, the FMD 200 is bonded to the neck 103 to create a seal such that fluid ingress and egress from the container 100 must pass through the top opening 206 of the FMD 200. The bonding of the FMD 200 to the container 100 can include, but is not limited to, adhesive bonding, melting, ultrasonic welding and/or heat staking, the rigid portion 201 to the interior surface 107 and or outer edge 104 of the neck 103. In some embodiments, the top portion 803 of the flexible portion 203 is sandwiched between the rigid portion 201 and inner surface 107. In yet still other embodiments, both the rigid portion 201 and flexible portion 203 are bonded to the neck 103.

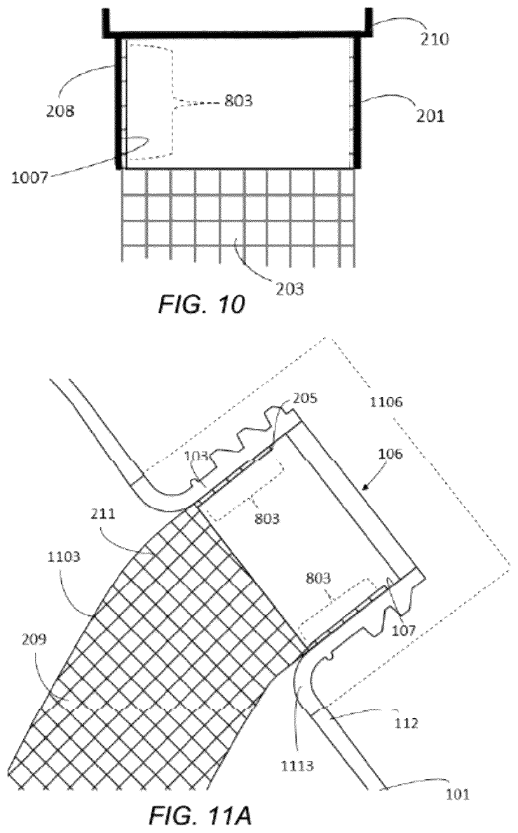

While the exemplary embodiments are described with respect to the flexible portion 203 attaching the exterior of the hollow body 208, it is to be appreciated that the location of attachment is not limiting. That is, in some embodiments and as illustrated in FIG. 10, the top portion 803 of the flexible portion 203 may be bonded to the inside surface 1007 of the hollow body 208. For example, bonding the flexible portion 203 on the inside surface 1007 may be desirable in embodiments wherein the exterior wall of the hollow body 208 includes retention members, such as those described with respect to FIGS. 3 and 7. In this way, the retention mummers 302 can be located on the bottom most portion of the hollow body 208 and is not overlapped by the flexible portion attachment. Bonding the flexible portion 203 to the inside surface 1007 can include, but is not limited to: welding, melting, heat staking, and/or adhesively sealing.

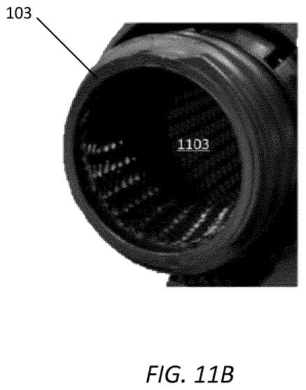

In accordance with another aspect of the present disclosure and with reference to FIGS. 11A and B, an FMD 1103 for a fuel container 100 is attached to an interior surface 107 of the container neck 103. The FMD 1103 is similar in many aspects to the flexible portion 203 of the FMD 200 described above and best understood with respect thereto. That is, the FMD 1103 is a generally a flexible, tubular, permeable, hollow structure terminating in a sealed or fused end, similar to fused end 204. The FMD 1103 may likewise composed of a permeable flexible material including a plurality of openings 209 (holes). That is, the FMD 1103 is a permeable material may be flexible, deformable, bendable and/or expandable and embodied as a fibrous textile, mesh or the like as described above with respect to the flexible portion 203. The openings 209 are sized to prevent the passage of a flame while allowing for a fluid to flow through the FMD 1103. When the FMD 1103 is attached to the neck 103 of a container (as in FIG. 11A) all fluid ingress or egress to or from the container and passing through the top opening 106 must also pass through the permeable medium (openings 209). Thus providing a continuous barrier between an ambient exterior and the interior volume defined by the hollow tank body 101.

Here, rather than the flexible portion 203 being attached to a rigid portion 201, a flexible FMD 1103 is bonded to the interior surface of the neck 103. Bonding may include but is not limited to welding, melting, heat staking, adhesively sealing. In some embodiments, the neck 103 is a separate component from the hollow tank body 101. That is, rather than a wall 112 of the hollow tank body 101 defining the neck 103, the wall 112 defines an opening 1106 in the hollow tank body 101 to which a separate neck piece 1113 may connect and/or be bonded to. In other words, the neck 103 comprises a neckpiece 1113 configured to attached to a container body 101 about an opening 1106. The neckpiece 1113 is a rigid portion 201 that a flexible FMD 1103 may bond thereto and extend therefrom. In some embodiments, the FMD 1103 is bonded to the neckpiece prior to connection of the neckpiece 1113 to the hollow tank body 101. In other embodiment, the FMD 1103 is bonded to the neckpiece after the connection of the neckpiece 1113 to the container body 101.

### Example Embodiments

The present disclosure is also directed to the following exemplary embodiments:

Embodiment 1: A flame mitigation device, comprising: a rigid portion comprising a hollow body and a flange at least partially surrounding an opening in the hollow body; and a flexible portion composed of a sheet of permeable material extending from the hollow body, wherein the sheet of permeable material defines an interior volume between a first end and a second end, wherein the first end has an opening in fluid communication with the hollow body, and wherein the second end is sealed.

Embodiment 2: The flame mitigation device of embodiment 1, wherein the sheet of permeable material comprises a plurality of openings.

Embodiment 3: The flame mitigation device of embodiments 1 or 2, wherein the plurality of openings are sized to prevent the passage of a flame through the sheet of permeable material while allowing for a fluid to flow through the sheet of permeable material.

Embodiment 4: The flame mitigation device of any of embodiments 1-3, wherein the rigid portion further comprises one or more barbs extending from a sidewall of the hollow body, and wherein the one or more barbs are engaged with one or more openings from the plurality of openings.

Embodiment 5: The flame mitigation device of any of embodiments 1-4, wherein the rigid portion further comprises one or more retention members extending from a sidewall of the hollow body.

Embodiment 6: The flame mitigation device of any of embodiments 1-5, wherein the one or more retention members are cantilevered or sloped away from the side wall of the hollow body.

Embodiment 7: The flame mitigation device of any of embodiments 1-6, wherein the flange is positioned at a first end of the hollow body, and wherein the one or more retention members are spaced away from the flange along the sidewall.

Embodiment 8: The flame mitigation device of any of embodiments 1-7, wherein an outer periphery of the flange is greater than an outer periphery of the hollow body.

Embodiment 9: The flame mitigation device of any of embodiments 1-8, wherein the hollow body has a substantially cylindrical shape, and wherein the flange in annular.

Embodiment 10: The flame mitigation device of any of embodiments 1-9, wherein an outer diameter of the flange is greater than an outer diameter of the hollow body.

Embodiment 11: The flame mitigation device of any of embodiments 1-10, wherein the flexible portion is a tubular, hollow structure.

Embodiment 12: The flame mitigation device of any of embodiments 1-11, wherein the hollow body extends into the opening at the first end of the flexible portion.

Embodiment 13: A container assembly, comprising: a fuel container that includes one or more walls that define a hollow tank body and a neck, wherein the neck defines an opening; and a flame mitigation device. Also, the flame mitigation device comprises: a rigid portion positioned within the neck, wherein a flange of the rigid portion abuts an outer portion of the neck or an inner surface of the neck; and a flexible portion composed of a sheet of permeable material extending from the rigid portion into an interior of the hollow tank body.

Embodiment 14: The container assembly of embodiment 13, wherein the opening provides fluid communication between the interior of the hollow tank body and an environment surrounding the hollow tank body.

Embodiment 15: The container assembly of any of embodiments 13-14, wherein the flange abuts the outer portion of the neck.

Embodiment 16: The container assembly of any of embodiments 13-15, wherein the flange abuts the inner surface of the neck, and wherein the inner surface is a ledge that project from a sidewall of the neck.

Embodiment 17: The container assembly of any of embodiments 13-16, wherein the rigid portion comprises a hollow body that is positioned within the neck and comprises an opening in fluid communication with the opening defined by the neck.

Embodiments 18: The container assembly of any of embodiments 13-17, wherein the rigid portion further comprises one or more retention members extending from a sidewall of the hollow body towards an inner sidewall of the neck.

Embodiment 19: A method of manufacturing a container assembly, the method comprising: providing a flame mitigation device comprising a flexible portion fixed to a rigid portion, wherein the flexible portion is composed of permeable material, and wherein the rigid portion comprises a hollow body; inserting the flame mitigation device into an opening of a fuel container; and bonding the flame mitigation device to the fuel container.

Embodiment 20: The method of embodiment 19, wherein inserting the flame mitigation device into the opening comprises positioning the flexible portion into an interior of the fuel container and seating the rigid portion within a neck of the fuel container that defines the opening.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, the terms “generally” and “substantially” are intended to encompass structural or numeral modification which do not significantly affect the purpose of the element or number modified by such term.

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed is:

1. A flame mitigation device, comprising:
a rigid portion comprising a hollow body and a flange at least partially surrounding an opening in the hollow body; and
a flexible portion composed of a sheet of permeable material extending from the hollow body, wherein the sheet of permeable material defines an interior volume between a first end and a second end, wherein the first end has an opening in fluid communication with the hollow body, and wherein the second end is sealed.

2. The flame mitigation device of claim 1, wherein the sheet of permeable material comprises a plurality of openings.

3. The flame mitigation device of claim 2, wherein the plurality of openings are sized to prevent the passage of a flame through the sheet of permeable material while allowing for a fluid to flow through the sheet of permeable material.

4. The flame mitigation device of claim 2, wherein the rigid portion further comprises one or more barbs extending from a sidewall of the hollow body, and wherein the one or more barbs are engaged with one or more openings from the plurality of openings.

5. The flame mitigation device of claim 2, wherein the rigid portion further comprises one or more retention members extending from a sidewall of the hollow body.

6. The flame mitigation device of claim 5, wherein the one or more retention members are cantilevered or sloped away from the side wall of the hollow body.

7. The flame mitigation device of claim 5, wherein the flange is positioned at a first end of the hollow body, and wherein the one or more retention members are spaced away from the flange along the sidewall.

8. The flame mitigation device of claim 1, wherein an outer periphery of the flange is greater than an outer periphery of the hollow body.

9. The flame mitigation device of claim 1, wherein the hollow body has a substantially cylindrical shape, and wherein the flange in annular.

10. The flame mitigation device of claim 9, wherein an outer diameter of the flange is greater than an outer diameter of the hollow body.

11. The flame mitigation device of claim 1, wherein the flexible portion is a tubular, hollow structure.

12. The flame mitigation device of claim 1, wherein the hollow body extends into the opening at the first end of the flexible portion.

13. A container assembly, comprising:
a fuel container that includes one or more walls that define a hollow tank body and a neck, wherein the neck defines an opening; and
a flame mitigation device that comprises:
a rigid portion positioned within the neck, wherein a flange of the rigid portion abuts an outer portion of the neck or an inner surface of the neck; and
a flexible portion composed of a sheet of permeable material extending from the rigid portion into an interior of the hollow tank body.

14. The container assembly of claim 13, wherein the opening provides fluid communication between the interior of the hollow tank body and an environment surrounding the hollow tank body.

15. The container assembly of claim 14, wherein the flange abuts the outer portion of the neck.

16. The container assembly of claim 14, wherein the flange abuts the inner surface of the neck, and wherein the inner surface is a ledge that project from a sidewall of the neck.

17. The container assembly of claim 14, wherein the rigid portion comprises a hollow body that is positioned within the neck and comprises an opening in fluid communication with the opening defined by the neck.

18. The container assembly of claim 17, wherein the rigid portion further comprises one or more retention members extending from a sidewall of the hollow body towards an inner sidewall of the neck.

19. A method of manufacturing a container assembly, the method comprising:
providing a flame mitigation device comprising a flexible portion fixed to a rigid portion, wherein the flexible portion is composed of permeable material, and wherein the rigid portion comprises a hollow body;
inserting the flame mitigation device into an opening of a fuel container; and
bonding the flame mitigation device to the fuel container.

20. The method of claim 19, wherein inserting the flame mitigation device into the opening comprises positioning the flexible portion into an interior of the fuel container and seating the rigid portion within a neck of the fuel container that defines the opening.
